(19) United States
(12) Patent Application Publication
(10) Pub. No.: US 2019/0068854 A1
(43) Pub. Date: Feb. 28, 2019

(54) Multifunctional Wireless LED-based Strobe for Still and Motion Photography

(71) Applicant: Alex Munoz, Reseda, CA (US)

(72) Inventor: Alex Munoz, Reseda, CA (US)

(21) Appl. No.: 15/686,647

(22) Filed: Aug. 25, 2017

(51) Int. Cl. H04N 5/225; H04N 5/235; H04N 5/232

(52) U.S. Cl. CPC H04N 5/2256; H04N 5/2352; H04N 5/2351; H04N 5/2355; H04N 5/2354; H04N 5/23203

(57) ABSTRACT

A multifunctional, wireless, LED-based strobe for still and motion photography is disclosed. The device is comprised of an LED lamp having a touch screen, onboard microcontroller, radio wave transmitter and receiver as well as a remote ‘hot shoe’. The invention is designed to be used with conventional still cameras and movie cameras. An object of the disclosure is to provide a means of customizing lighting conditions manually, automatically and in real time. Several proprietary lamps can also be tailored and controlled by the device.

### FIELD OF THE INVENTION

The present invention generally relates to LED lighting systems. More specifically, it relates to a multifunctional, wireless, LED-based strobe for still and motion photography.

### BACKGROUND

Early strobe lights for flash photography began with flash powders made of magnesium and potassium chlorate and while these materials created quick flashes for high shutter speeds—they were hazardous. In the early 1900s a French zoologist invented the flash bulb made up of a glass bulb with aluminum shards and filled with oxygen. In late 1950s electronic, rechargeable flash strobes using xenon gas were introduced. With the advent of digital imaging, LEDs and microcontrollers, lighting has undergone significant improvements. Photographers and technology experts have been inventing ways to manipulate and enhance lighting effects. U.S. Pat. No. 8,203,641 granted to Mori disclosed a display processing apparatus to set auto bracketing values in a camera. This disclosure is generally related to exposure bracketing controlled by the camera's shutter speed, aperture. It does not account for flash bracketing This patent does not allow for multiple bracketing schema over the same time period. U.S. Pat. No. 9,250,499B2 granted to Clark disclosed a camera ‘hot shoe’ adapter to relay informality wirelessly to a remote strobe. It provides only limited exposure modifications to the strobe. United States Patent No. 20050174473A1 granted to Morgan disclosed strobe lights with features that allow for the creation of particular moods or a desired saturation or hue; however, it is focused on enhancing saturation through light modification but not through the flash duration, otherwise modulating the LED signal. United States Patent No. 20120044374 granted to Pohlert and others, disclosed a smart strobe panel that uses LEDs, but not integrate on-board processor to control the LED module. Furthermore, the battery must attach to the outside of the frame unit, whereas in the present disclosure, the power supply is neither limited to a battery, nor does it attach to the light housing directly. In addition it appears unable to control the strobe duration, intensity, shape, pattern or perform modulation. United States Patent No. 20070248342 granted to Tamminen and Perala disclosed a smart lighting system with rudimentary parameters controlled by software. This disclosure uses LEDs to illuminate a subject and measure its reflectance in order to calculate exposure for the camera more accurately; however, it is not meant to specifically to illuminate a subject. United States Patent No. 20130147986 granted Chen disclosed an image capture method with auto exposure control that uses an image to calculate exposure, whereas the current disclosure assists exposure calculations for an external light condition. United States Patent No. 20090136224 granted to Aoyagi disclosed a sensor that detects the amount of light reflected back from the photographic subject. This disclosure does not modulate the light power signal, change the power for multiple light sources. While many of these inventions have begun to fine-tune various lighting characteristics, none were found in the prior art that utilize a network-approach to incorporate a multitude of strobes that interact with specific camera operations. The current disclosure addresses limitations in the prior art by offering an almost infinite combination of LED power and duration adjustment, nodulation, and programmable light shape pattern, all accessible by the user through an interface.

### SUMMARY OF THE INVENTION

The device herein disclosed and described provides a solution to the shortcomings in the prior art through the disclosure of a multifunctional, wireless, LED-based strobe for still and motion photography. An object of the invention is to provide photographers and filmmakers with the ability to adjust a plurality of lighting parameters across a range of lights and cameras using a single ‘master lamp.’ This master lamp is generally comprised of a large LED, a touch screen interface, an internal microcontroller, onboard memory and a radio transmitter and receiver.

Another object of the invention is to leverage camera setting (such as, but not limited to: shutter speed, ISO sensitivity and Aperture) into the strobe adjustment process. These settings are transferred from a camera to the master lamp's controller by means of either a radio transmission sent from a hot shoe transmitter mounted on the camera's strobe adaptor, a cable or other wireless connection.

Another object of the aforementioned invention is to provide a means for customizing light parameters for a multitude of lamps. The master lamp can communicate with several proprietary satellite lamps using the onboard radio transmitter that is controlled by an internal microprocessor attached to a touch screen that allows a user to select various lights and lighting conditions such as duration, modulation and intensity.

Another object of the invention is to provide an increase in the dynamic range of a an image using lighting methods. When filming a subject with highlights and shadows, conventional cameras increase dynamic range by taking several shots with different aperture, ISO, or shutter speed settings (known as bracketing) because a discharge-based strobe needs to recharge and thus cannot be used to automate the process without adverse effects on the image quality. The current disclosure uses a microprocessor to control light levels instantaneously allowing for light-based bracketing to take place with low latency, negating any negative effects otherwise associated with a similar approach and traditional discharge lamp technology.

Another object of the invention is to provide a means to control strobe emission shapes and patterns. Firmware in the microprocessor allows power to the lamps to be modulated and controlled and preset via the touch screen to generate a variety of light profile signatures.

Another object of the invention is to enhance ‘through the lens metering.’ In conventional cameras, a pre-flash takes place when a photographer presses the shutter button and relays proper flash setting information to the camera's image sensor within microseconds. After the pre-flash, the proper exposure is set, the shutter is opened and the picture is recorded. The current disclosure provides a constant pre-flash equivalent to the actual desired light intensity, which does not delay the shutter opening process during a shoot and also allows for an image preview.

It is briefly noted that upon reading this disclosure, those skilled in the art will recognize various means for carrying out these intended features of the invention. As such, it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways, which will be obvious to those skilled in the art. In addition, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the invention.

FIG. 2 is a bottom view of the invention.

FIG. 3 is a front view of the invention.

FIG. 4 is a side view of the invention.

FIG. 5 is a section view of the invention.

FIG. 6 is a perspective view of the invention with camera transmitter and satellite lamps.

FIG. 7 is a diagrammatic view of the invention's touch screen interface.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

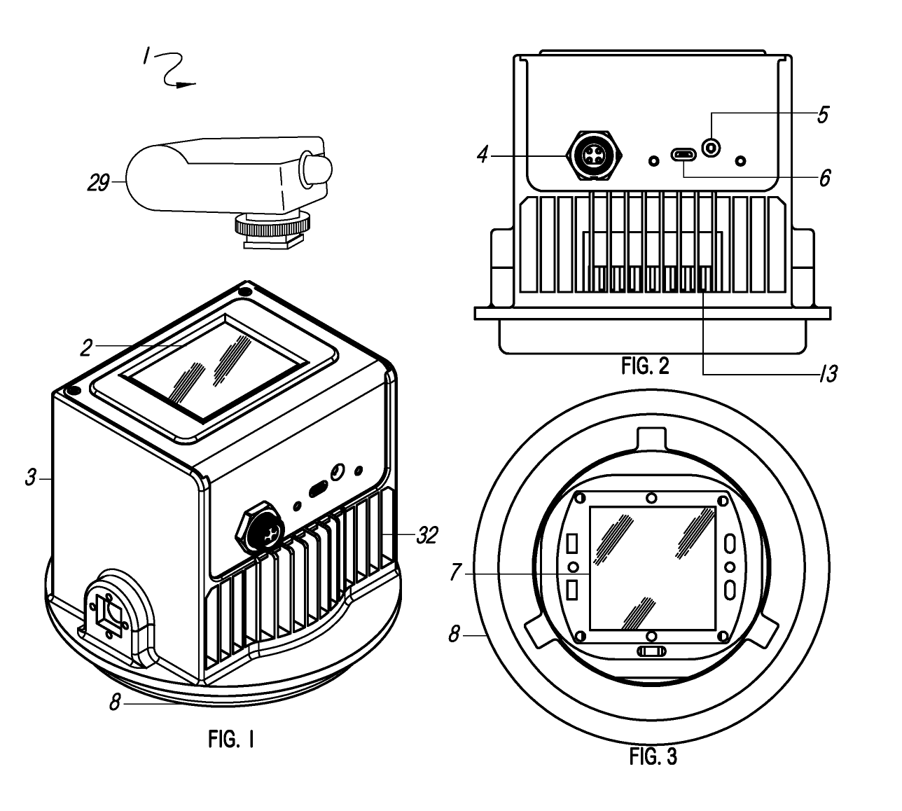

FIG. 1 showing a perspective view of the invention comprised of a cube-shaped master unit 1 having an outer housing 3 constructed of a rigid material such as plastic, metal and the like. One end of said outer housing 3 having a touch screen 2 affixed flush to the surface and comprised of a graphical user interface and being connected to the invention's microprocessor. A front side of said outer housing 3 also having a plurality of rectangular apertures with protruding fins called cooling grill 32. Another end of said invention having a cylindrical member 8 spanning the width of master unit 1 and configured to receive a multitude of light modifier attachments. FIG. 1 also showing camera remote 29 comprised of a rectangular-shaped device being made of a rigid material such as plastic or metal with one end having a hot shoe connection capable of being selectively affixed to a conventional camera hot shoe coupling. Said remote 29 having an internal microcontroller capable of obtaining and transmitting a multitude of camera settings and functions such as, but not limited to, shutter speed, ISO, aperture and the like by means of existing communication protocols in addition to SYNC or GENLOCK standard transference methods and sending said camera data to master unit 1 by means of an onboard 2.4 GHz transmitter.

FIG. 2 showing a bottom view of the aforementioned invention master unit 1 having a power supply adaptor 4, a universal serial bus adaptor 6, and a wired trigger connection 5 configured proximally on a side. Said power supply adaptor 4 being connected to the microprocessor 13 and light emitting diode (LED) 7.

FIG. 3 showing a front view of the invention having cylindrical member 8 having a cylindrical inset adapted to receive LED 7 by means of screws therein. Said cylindrical member 8 also having at least three slots arranged in a radial fashion proximal to said unit 1 and disposed to receive a multitude of lighting attachments as mentioned.

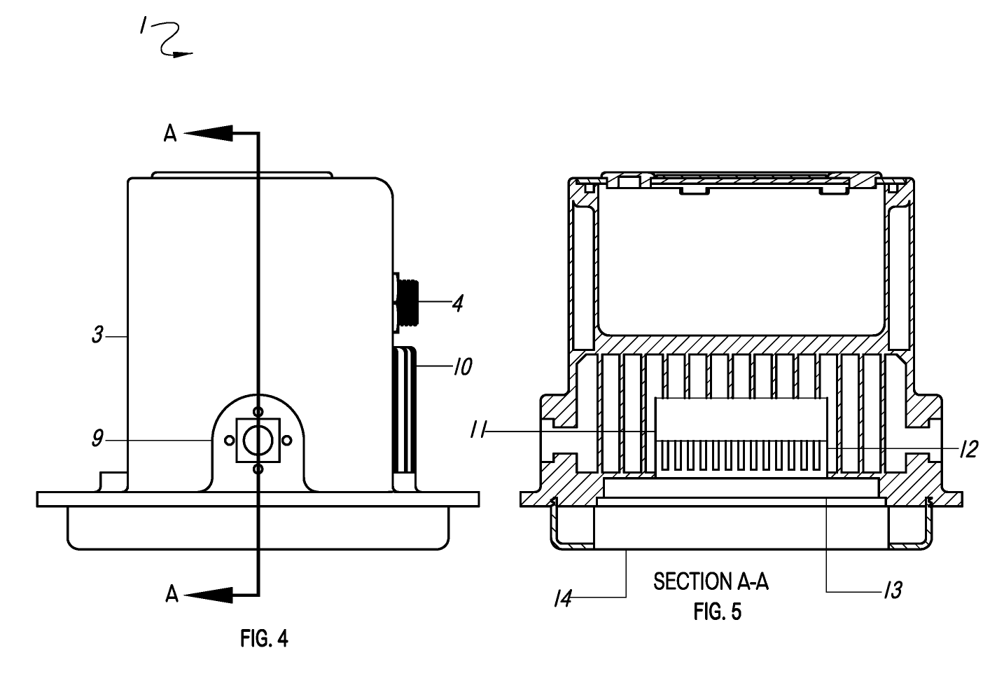

FIG. 4 showing a side view of the invention and having at least one stand mount 9 comprised of a square aperture and another circular aperture inside configured perpendicular to the longitudinal axis of unit housing 1 and disposed to receive a variety of tripod mounting brackets allowing said unit one to tilt at various angles.

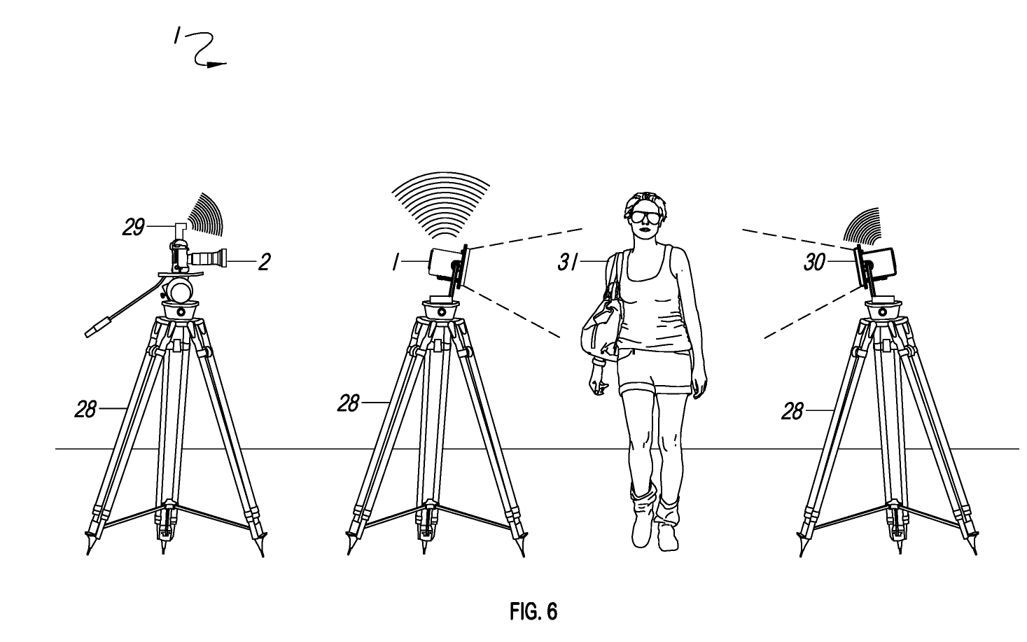

FIG. 5 illustrating a section view of the invention with microprocessor 13 being affixed proximally to the internal portion of cylindrical member 8. Another end of said microprocessor 13 having cooling fan 11 and heat sink 12 affixed to it by means of at least four screws mounted perpendicular to its longitudinal axis. The aforementioned microprocessor 13 comprised of a bus-width architecture and may consist of, but not limited to, a microcontroller or programmable logic controller and the like. Said microprocessor also having: an onboard radio receiver and transmitter, internal random access memory and proprietary firmware. The aforementioned software and processor contained within master unit 1 utilizing data sent to onboard radio receiver from camera remote 29, as well as potential lighting information obtained from other lamps having the ability to transfer data via radio transmitters (as shown in FIG. 6).

Algorithms in software inside said microprocessor of master unit 1 utilizing said data to determine several lighting conditions—including but not limited to, appropriate flash duration, flash power, and other settings potentially relevant to the exposure of an image. In another embodiment, master unit 1 also having the capability to send lighting adjustment information by means of radio frequency to other compatible lamps 30 in FIG. 6 as part of a desired light composition using said touch screen 2 (to be discussed in a later section) in order to shape overall light output and modify light parameters on a scene.

The aforementioned software in master unit 1 having an algorithm with the capability to control lighting sequences and enhance camera bracketing. Said algorithm sends commands using fast radio frequencies to internal 7 and external LED lamps 30 to control light levels instantaneously allowing for bracketing to take place as quickly as a camera can take sequential images. For example, when a user with a camera having an ability to take 10 images per second attempts a bracketing sequence, a five-image sequence will be completed in half a second, dramatically increasing the chance of success for a bracketed composition by limiting motion blur between images and preventing artifacts from contaminating the images.

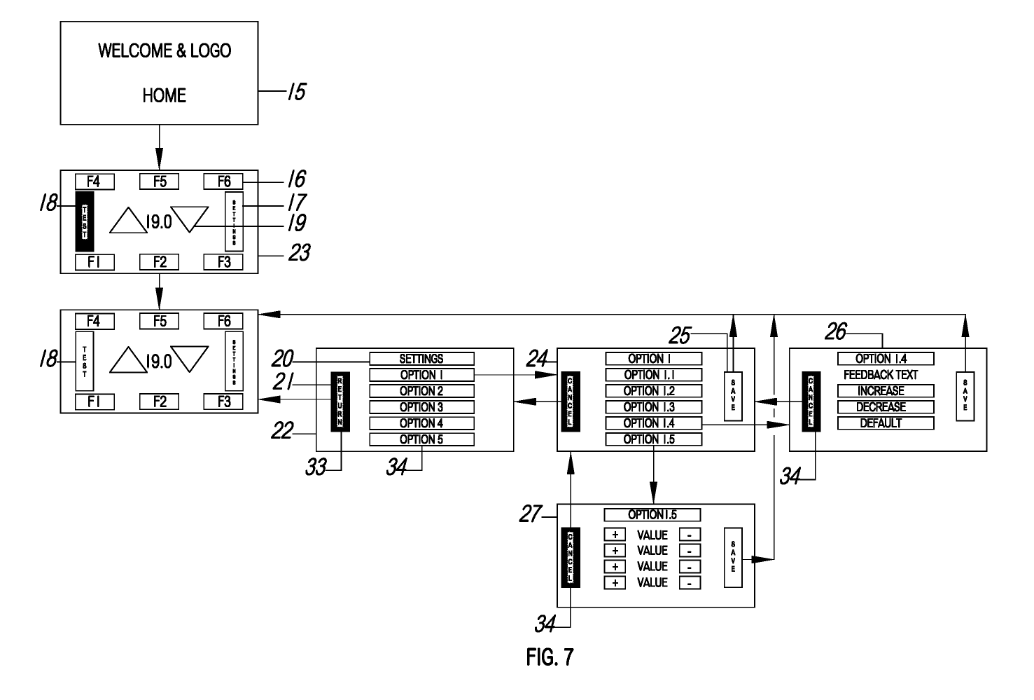

The aforementioned software in master unit 1 having an algorithm with the capability to send commands to said internal LED 7 and external LED lamps 30 and provides a constant pre-flash upon requested preset in the touch screen 24 in FIG. 7 (to be discussed later in this document) based on the user's preferences. Said software feature eliminating the delay in the shutter opening process present during conventional digital cameras. In another embodiment, said constant pre-flash function may allow for an image preview inside a compatible camera before an image is recorded.

FIG. 6. illustrating an embodiment whereby master unit 1 interacting with compatible lamp 30 and said camera remote 29 selectively affixed to a conventional camera with hot shoe adaptor 2. FIG. 6. also showing conventional tripod 28 selectively affixed to said master unit 1's stand mount 9 holding said unit 1 at a preselected angle.

FIG. 7 depicting the various screens of the aforementioned touch screen 2 with an initial welcome screen 15. Once said master unit 1 initializes properly, main screen 23 being presented to a user. Said proper initialization and a state of being ready confirmed by TEST bar 18 changing from the color red to the color green. Main screen 23 having a plurality of function buttons (F1, F2, etc.) 16 allowing a user to program various lighting and camera commands (such as but not limited to hue, intensity, shutter speeds etc.) and to jump to other screens. Main screen 23 also having settings buttons 17 (also having a plurality of customizable functions similar to said function buttons) allowing a user to arrive at setting screen 22 having a plurality of lighting setting options 33. Said option buttons allowing a user to enter submenu option screens 24, 26 and 27. Said subscreens 24, 26 and 27 once again, having user-defined functions as well as having cancel buttons 34 allowing a setting to be abandoned and allowing the user to return to a previous screen. Said subscreens 24, 26 and 27 also having save buttons allowing a user to save a setting to said onboard memory and returning them to main screen 18.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A photographic lamp system for illuminating a subject comprised of the following parts:
a.) A master light emitting diode (LED) lamp;
b.) A plurality of external LED lamps; and
c.) A remote camera-mounted flash.

2. The photography LED-based lamp system of claim 1 wherein the master lamp having an onboard computer with internal memory, software, a touch screen interface, and wireless transmitter allowing it to interact with, and control external LED lamps, remote camera-mounted flash, and a camera simultaneously.

3. The photography LED-based lamp system of claim 1 wherein the external LED lamps having an onboard microcontroller with wireless receiver to receive commands from, and be controlled by, the master LED lamp.

4. The photography LED-based lamp system of claim 1 wherein the remote camera-mounted flash having a microcontroller and wireless transmitter allowing it to send image data to, and be controlled by, the master LED lamp.

5. The master lamp's computer of claim 2 controlling lighting parameters such as, but not limited to, range, intensity, power level, light pattern and the like of a plurality of external LED lamps and camera-mounted flashes simultaneously.

6. The master lamp's computer of claim 2 controlling camera parameters such as, but not limited to number of images taken, pre-flashes, shutter speed, ISO sensitivity, lens metering, aperture, bracketing and the like of a plurality of cameras simultaneously.
